(19) United States
(12) Patent Application Publication
(10) Pub. No.: US 2002/0172798 A1
(43) Pub. Date: Nov. 21, 2002

(54) Cloth for the seat of an office chair

(76) Inventor: Ching-Hui Chi, San Chung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/855,598

(22) Filed: May 16, 2001

(51) Int. Cl. B32B 5/12

(52) U.S. Cl. 428/105

(57) ABSTRACT

A cloth for the seat of an office chair has a middle layer made of polyester. The middle layer is sandwiched between a bottom and a top layers also made of polyester, and has fibers arranged for spaces to form among the fibers, and between the bottom and the top layers; the top layer has meshes, and the distance from the bottom layer to the top layer can be as long as 5 millimeters such that the cloth for the seat is resilient. The bottom, middle and top layers are formed integrally and dyed desired colors under high temperature. And, the cloth for the seat has satisfactory ventilation because air can flow in and out off same through the meshes of the top layer and the spaces among the fibers of the middle layer.

### BACKGROUND OF THE INVENTION

The present invention relates to a cloth for the seat of an office chair, and particularly to one, which is resilient, and has relatively good ventilation for a sitter to feel comfortable on it.

Office staff sit on office chairs for relatively long time during office hours. Therefore, it is important to provide the office staff with office chairs made according to ergonomics such that they can sit comfortably to work happily and efficiently. Many efforts have been made to improve office chairs, e.g. providing office chairs with various attractive colors and designs, and using better materials. The materials for the seat of an office chair that have been used so far are leather, cloth and plastics. Because leather has relatively high cost, an office chair made with leather seat is too expensive for average companies or persons. And, leather's lack of ventilation is also a drawback.

Plastics are cheaper than leather, however, it also has the disadvantage of lack of ventilation. Cloth has better ventilation than both leather and plastics, and can be colorful; however it is likely to get stained, and the ventilation is still not satisfactory. Moreover, whichever of the above materials is used, the connection to the chair is also a problem because it has to be stretched first, and then fitted onto a sponge rubber of the office chair. And, the sponge rubber decides the softness of the seat.

### SUMMARY OF THE INVENTION

Therefore, it is a main object of the present invention to provide a cloth for the seat of an office chair which is resilient, and has satisfactory ventilation for a person to sit on the seat comfortably.

The cloth for the seat of an office chair in the present invention has a bottom layer, a middle layer and a top layer; all of them are made of polyester and are made integrally.

The middle layer is sandwiched between the bottom and the top layers, and has fibers having spaces formed between them; the fibers can be arranged perpendicular to both the top and the bottom layers or in a sloping position between the top and the bottom layers. The top layer has meshes. The middle layer formed of the fibers is relatively thick (about 2 to 5 millimeters) for the cloth of the seat to be resilient; thus, a person can sit comfortably on it, and shock can be reduced by the middle layer when a person sits onto the office chair too hard.

And, a person sitting on the office chair for a long time will not feel too hot at his or her buttock and thigh because air can easily flow in and out of the cloth for the seat through the meshes of the top layer and the spaces in the middle layer for preventing heat from accumulating.

### BRIEF DESCRIPTION OF THE DRAWINGS

This invention will be better understood by referring to the accompanying drawings, wherein:

FIG. 1 is a fragmentary perspective view of the cloth for the seat of an office chair according to the present invention.

FIG. 2 is a view of an office chair with a conventional cloth being connected to the seat.

FIG. 3 is a photo of a part of the cloth for the seat of an office chair according to the present invention.

FIG. 4 is a photo of several clothes with different colors of the present invention.

### DETAILED DESCRIPTION OF THE PREFERRED EMBODIMENT

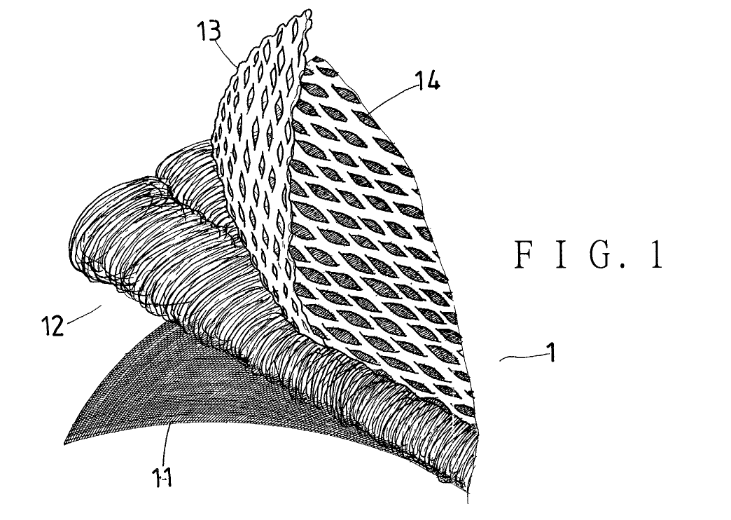

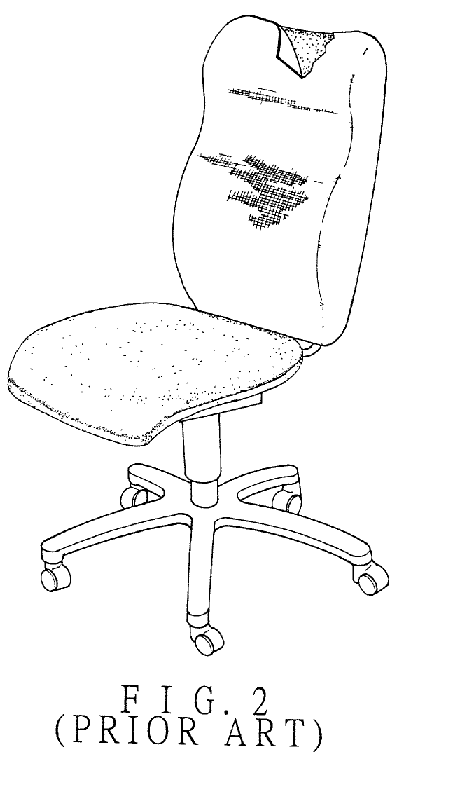

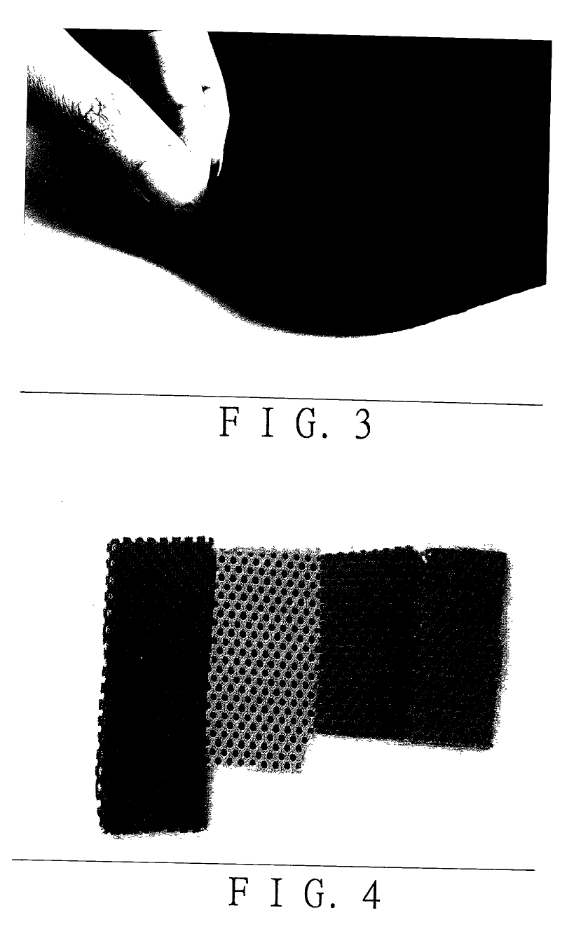

Referring to FIG. 1, a cloth 1 for the seat of an office chair includes a bottom layer 11, a middle layer 12 and a top layer 13. The bottom layer 11, the middle layer 12 and the top layer 13 are combined and dyed desired colors under high temperature and cut into a desired shape for connection to the seat and the back of an office chair. The layers 11, 12 and 13 are made of polyester, and the top layer 13 is treated with anti-stain process. The layers 11, 12 and 13 can be further sewn together on the edges if necessary.

The middle layer 12 is arranged such that the fibers are perpendicular to both the bottom and the top layers 11 and 13 or form sloping lines between the layers 11 and 13 for a distance of preferably 2 to 5 millimeters to be provided between the bottom and the top layers 11 and 13. Thus, the cloth 1 has good resilience and ventilation because of the arrangement of the fibers and the space among the same. The top layer 13 has meshes 14 for permitting air to go in and out of the middle layer 12 therethrough; thus, the cloth 1 has good ventilation. Furthermore, the meshes 14 of the top layer 13 provide the seat with a pleasant and attractive appearance and a friction against the sitter for preventing the sitter from slipping off the seat.

From the above description, the cloth for the seat of an office chair in the present invention can be known to have desirable feature as follows:

1. the cloth is formed with the resilient middle layer 12 being sandwiched between the top and the bottom layers 13 and 11 so it can absorb shock;

2. before the cloth is connected to the office chair, the layers 11, 12 and 13 are sewn together from the edges such that no edge splits are exposed to outside;

3. the cloth of the present invention is even lighter than ordinary clothes, and has good touch, giving a comfortable and pleasant feeling to the sitter;

4. the seat is not likely to get stained, and can be cleaned very easily because of the anti-stain treatment;

5. the material of the cloth, polyester, can be dyed various colors easily for providing the office chair with an attractive appearance;

6. because the cloth itself is resilient, no sponge rubber is needed to fit onto the chairs; and because the cloth has good ventilation, no additional vent cushion is needed.

What is claimed is:

1. A cloth for a seat of an office chair, comprising
a middle layer, said middle layer being made of polyester; said middle layer being sandwiched between a bottom and a top layers made of polyester; said middle layer being relatively thick (about 2 to 5 millimeters); said middle layer having fibers arranged for spaces to form among same, and between said bottom and said top layers for air to flow in and out of said middle layer through meshes of said top layer, as well as for said cloth to be resilient;
said bottom, middle and top layers being made integrally and being dyed desired colors under high temperature.

2. The cloth for a seat of an office chair as claim in claim 1, wherein said fibers of said middle layer are substantially perpendicular to both said bottom and said top layers.

3. The cloth for a seat of an office chair as claim in claim 1, wherein said fibers of said middle layer are arranged in a sloping position between said bottom and said top layers.
